(19) United States
(12) Patent Application Publication
(10) Pub. No.: US 2018/0051679 A1
(43) Pub. Date: Feb. 22, 2018

(54) Thruster

(71) Applicants: COMMONWEALTH OF AUSTRALIA AS REPRESENTED BY DEFEN- CE SCIENCE AND TECHNOLOGY GROUP OF THE DEPARTMENT, Canberra (AU); THE UNIVERSITY OF SYDNEY THE UNIVERSITY OF SYDNEY, Sydney (AU)

(72) Inventors: Joseph Khachan, Sydney (AU); Lachlan John Emblen Blackhall, Sydney (AU); Xioafeng Wu, Sydney (AU); Iain Cartwright, Canberra (AU); Weitang Li, Canberra (AU); Shyam Mehta, Canberra (AU); B. Upul Heyshan Mendis, Canberra (AU)

(21) Appl. No.: 15/552,198

(22) PCT Filed: Feb. 19, 2016
(86) PCT No.: PCT/AU2016/050116

§ 371 Date: Aug. 18, 2017

(30) Foreign Application Priority Data
Feb. 20, 2015 (AU) 2015900603

(51) Int. Cl. F03H 1/00; B64G 1/40; H05H 1/48; H05H 1/50

(52) U.S. Cl. CPC F03H 1/0025; H05H 1/50; H05H 1/48; B64G 1/405

(57) ABSTRACT

A thruster comprising: a chamber to contain a fluid; a plurality of nozzles to exhaust neutral particles derived from the fluid in the chamber, wherein each nozzle has a converging section and the converging section includes a first electrode; a second electrode located distal to the first electrode to provide a voltage differential between the first and second electrodes sufficient to create plasma ions from the fluid and the voltage differential accelerates the plasma ions on a flow path through the converging section, and wherein at least one or more of the accelerated plasma ions are neutralised to form the neutral particles by charge exchange with other neutral particles, or by recombination with electrons, on the flow path.

### TECHNICAL FIELD

The present disclosure relates to a thruster. The thruster provides energised particles to provide thrust that may be used for manoeuvring a vehicle.

### BACKGROUND

One method of moving an object is to provide the object with a thruster. By ejecting mass in a specified direction from the thruster, this imparts an equal and opposite momentum to the object. Thrusters may include rocket engines that burn a propellant fuel to create a jet of energised propellant gas that is exhausted from a nozzle of a thruster. Another form of thruster may include ejecting pressurised fluid (such as pressurised gas) from a nozzle. Yet another form of thruster includes electric propulsion that ejects particles that have been accelerated by electromagnetic fields.

One form of electric propulsion includes an ion propulsion system where a gas is ionised to provide ionised particles. The ionised particles are then accelerated by the electrodes and the accelerated ionised particles are subsequently neutralised by a neutralising apparatus. Neutralisation may be achieved by injecting electrons into the ion plume so that the charge on a vehicle will remain neutral. Neutralisation is important as there may otherwise be a build-up of negative charge on the vehicle that will eventually stop the exit of ions.

Injection of electrons into the ion plume may be provided by an electron gun mounted external to the thruster to neutralise the exiting ions. The electron gun is an additional power-consuming component that adds to the mass and power consumption of a vehicle.

### SUMMARY

A thruster comprising: a chamber to contain a fluid; a plurality of nozzles to exhaust neutral particles derived from the fluid in the chamber, wherein each nozzle has a converging section and the converging section includes a first electrode; a second electrode located distal to the first electrode to provide a voltage differential between the first and second electrodes sufficient to create plasma ions from the fluid and the voltage differential accelerates the plasma ions on a flow path through the converging section, and wherein at least one or more of the accelerated plasma ions are neutralised to form the neutral particles by charge exchange with other neutral particles, or by recombination with electrons, on the flow path.

A thruster comprising: a chamber to contain a fluid; a plurality of nozzles to exhaust particles of the fluid from the chamber, wherein each nozzle has a converging section and the converging section includes a first electrode; a second electrode located distal to the first electrode to provide a voltage differential between the first and second electrodes sufficient to create plasma ions from the fluid and the voltage differential accelerates the plasma ions on a flow path through the converging section, and wherein at least one or more of the accelerated plasma ions are neutralised by charge exchange with neutral particles, or by recombination with electrons, on the flow path.

The thruster may have the plurality of nozzles arranged in an array. The array may include a two-dimensional array with regular spacing between each nozzle in the plurality of nozzles. The thruster may include a nozzle element having the plurality of nozzles in an array.

At least a portion of the nozzle element, having the plurality of nozzles in an array, may be substantially planar. The nozzle element may be formed of an electrically conductive material and the nozzle element forms at least part of the first electrode.

The nozzle may include an electrically conductive lining at the converging section to form at least part of the first electrode. The nozzle element may be formed of a conductive material and the nozzle further having the electrically conductive lining. In one alternative the nozzle element may be formed of a non-conductive material and the nozzle further having the electrically conductive lining. In yet another example, the nozzle element is formed of a semi-conductive material and the nozzle further having the electrically conductive lining.

The nozzle element may be formed of any one or more of a conductive, non-conductive or semi-conductive material, and wherein the nozzle includes an electrically conductive lining at the converging section to form at least part of the first electrode.

The converging section of each of the nozzles may converge towards a respective nozzle axis, and wherein the respective nozzle axis of each of the plurality of nozzles is substantially parallel.

In the thruster, the converging section may define a nozzle aperture that is frustoconical. The nozzle aperture may have a generator angle of between about 5 degrees and about 45 degrees from a nozzle axis of the nozzle aperture. In some examples, the nozzle aperture may have a generator angle of between about 15 degrees and about 45 degrees from a nozzle axis of the nozzle aperture. The frustoconical nozzle aperture may have a circular inlet and a circular outlet diameter, wherein the inlet has an inlet diameter in the range of about 1 to about 20 millimetres and the outlet has an outlet diameter in the range of about 0.1 to about 8 millimetres. In some examples, the frustoconical nozzle aperture may have a circular inlet and a circular outlet diameter, wherein the inlet has an inlet diameter in the range of about 0.5 to about 4 millimetres and the outlet has an outlet diameter in the range of about 0.1 to about 0.8 millimetres. The distance between the inlet diameter and outlet diameter along the nozzle axis may be in the range of about 1 to about 20 millimetres. In some examples, the distance between the inlet diameter and outlet diameter along the nozzle axis may be in the range of about 5 to about 20 millimetres.

In the thruster, the plurality of nozzles may be disposed at a first end of the chamber and the second electrode may be disposed at a second end of the chamber, wherein at least one chamber wall formed of non-conductive material separates the first and second ends.

The thruster may further include at least one shield located in the chamber proximal to a chamber wall, wherein the shield is electrically isolated from the first and second electrode.

The thruster may further include a cover to define at least part of the chamber. The cover may be formed of an electrically conductive material and is at least part of the second electrode.

In the thruster, the second electrode may be formed of an electrically conductive material.

The thruster may be a substantially rectangular cuboid.

The thruster may further include a voltage source connected to the first and second electrodes so that the first electrode is a cathode and the second electrode is an anode.

The thruster may further include a third electrode located adjacent to a path of the exhausted particles, wherein the third electrode is a second anode.

The thruster may further include a fluid inlet to supply fluid to the chamber, wherein the fluid inlet is located proximal to the second electrode. The fluid inlet may further include a plurality of inlets to distribute fluid entering the chamber.

The fluid inlet may, in some alternatives, include a plurality of nozzles to distribute fluid entering the chamber.

The thruster may further include a fluid flow control means to control the fluid flow into the chamber, wherein the fluid flow control means provide fluid to maintain an operating pressure inside the chamber in accordance with the formula:

P=K/D

where

P is the pressure inside the chamber in milliTorr;

D is the distance between the first and second electrodes in millimetres; and

K is a constant between 200 and 200000 milliTorr mm, and is preferably around 6000 milliTorr mm.

The thruster may have a length of the chamber between the first and second electrode of at least about 20 millimetres, and preferably of at least about 25 millimetres.

The thruster may have a width of the chamber in the range of about 10 to 50 about millimetres.

The thruster may have a flow rate in the range of about 0.2 to about 6 standard cubic centimetres per minute.

The thruster may have a number of nozzles in the plurality of nozzles in the range of 3 to 1000. In some examples, the thruster may have a number of nozzles in the plurality of nozzles in the range of 10 to 1000.

The fluid used in the thruster may include alcohol, water or a combination thereof. The alcohol may be one or more of methanol, ethanol, propanol (including n-propanol and isopropanol), and butanol (including n-butanol and t-butanol) and isopropyl alcohol or mixtures thereof. In one embodiment, the alcohol is isopropyl alcohol or similar.

The thruster may further include a permanent magnet to provide a magnetic field in the chamber. The magnetic field may assist in intensifying the plasma density.

The thruster may include at least one of the chamber and nozzle to be constructed of one or more silicon wafers.

A satellite including at least one thruster as described above.

A method of manufacturing a thruster described above, including the steps of: etching a first pattern on a first substrate; etching a second pattern on a second substrate; bonding the first and second substrate to form at least one of the chamber, plurality of nozzles, first electrode and second electrode of the thruster.

### BRIEF DESCRIPTION OF DRAWINGS

Examples of the present disclosure will be described with reference to:

FIG. 1 is a cross-sectional view of a thruster according to a first embodiment;

FIG. 2 is an enlarged cross-sectional view of a portion of the thruster of FIG. 1;

FIGS. 3a and 3b show exploded perspective views of the thruster of FIG. 1;

FIG. 4a is a perspective view of the thruster of FIG. 1;

FIG. 4b is an alternative perspective view of the thruster of FIG. 1;

FIG. 5a is a perspective view of a nozzle element of the thruster of FIG. 1;

FIG. 5b is an alternative perspective view of the nozzle element of FIG. 1;

FIG. 6 is a front view of a variation of a nozzle element;

FIG. 7a illustrates a cross-sectional side view of a thruster according to a second embodiment;

FIG. 7b illustrates the process of wafer etching nozzles in the nozzle element;

FIG. 8 illustrates a cross-sectional side view of a thruster according to a third embodiment;

FIG. 9 illustrates a cross-sectional side view of a thruster according to a fourth embodiment;

FIG. 10 illustrates a cross-sectional side view of a thruster according to a fifth embodiment;

FIG. 11 illustrates a cross-sectional side view of a thruster according to a sixth embodiment;

FIG. 12 illustrates an exploded cross-sectional view of the thruster in FIG. 11;

FIG. 13 illustrates a schematic of a fluid system for supplying fluid to a thruster;

FIG. 14a is a perspective view of a fluid control means;

FIG. 14b is a cross-sectional side view of a fluid control means of FIG. 14a along the length of a groove;

FIG. 15 is a perspective view of a satellite;

FIG. 16 is a perspective view of a nozzle element according to a seventh embodiment; and

FIG. 17 illustrates a cross-sectional side view of a thruster according to an eighth embodiment.

### DESCRIPTION OF EMBODIMENTS

### Overview

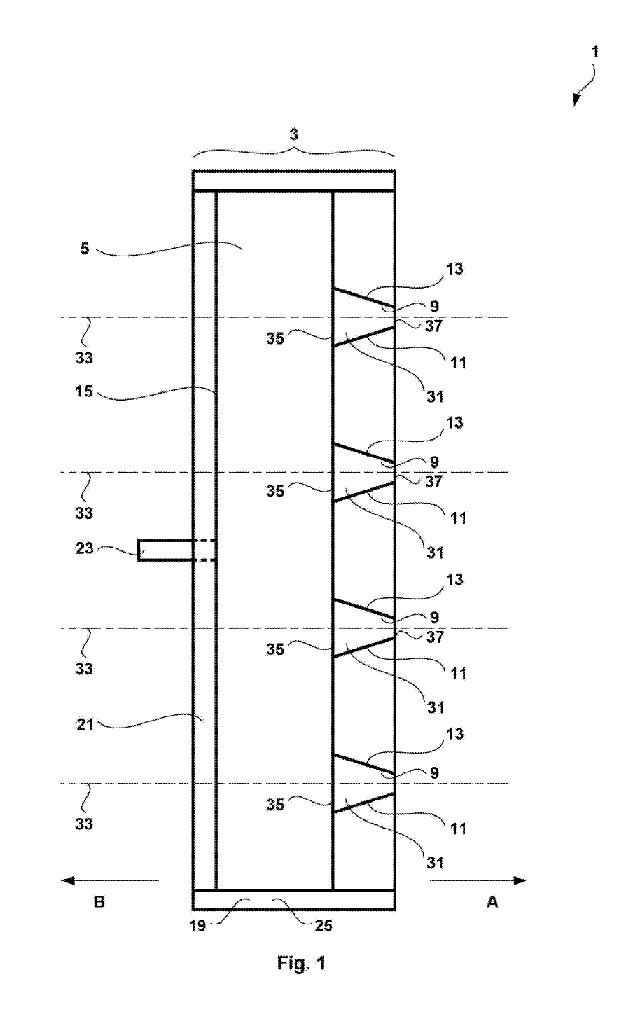

Referring to FIGS. 1 to 3, there is provided a thruster 1 for generating thrust by exhausting a flow of particles 8 from the thruster 1. The thruster 1 has a chamber 5 to contain a fluid 7. A plurality of nozzles 9 allow neutral particles 14, derived from the fluid, to be exhausted from the chamber 5 and each nozzle 9 has a converging section 11 that includes a first electrode 13. A second electrode 15 is located distal to the first electrode 13 so that a sufficient voltage differential provided between the first and second electrodes 13, 15 creates plasma ions 10 from the fluid 7 inside the chamber 5. The voltage differential between the first and second electrodes 13, 15 also accelerates the plasma ions 10 in a flow path through the converging section 11. At least one or more of the accelerated plasma ions 12 are neutralised to form the neutral particles by charge exchange with other neutral particles 16, or by recombination with electrons, on the flow path.

The accelerated plasma ions 12 that are neutralised and exhausted from the thruster 1 provide neutral exhaust particles 14. Particles 8 that include accelerated ions 12 and/or neutral exhaust particles 14, flow in direction A to provide thrust to the thruster 1 in an opposing direction B.

The neutralisation of accelerated ions by charge exchange with neutral particles or by recombination with electrons 18 in the flow path may reduce or ameliorate the need to have a neutralising apparatus, such as an electron gun, for neutralising the ions in the exhaust plume. The configuration of the thruster 1 with a plurality of nozzles for exhausting particles from a common chamber (or in some embodiments multiple chambers) may provide a thruster 1 to have dimensions and a form factor that is compact and space efficient for the given thrust output. This may be useful for applications where space and mass are at a premium such as vehicles in space. The thruster 1 may have application with smaller satellites known as “CubeSats” or “nanosatellites”, in which volume and mass of components are particularly important. However, the thruster 1 may have application with larger satellites and it is to be appreciated that multiple thrusters 1 could be used and/or the thruster 1 may be scaled to a larger size to suit performance requirements.

### Operation

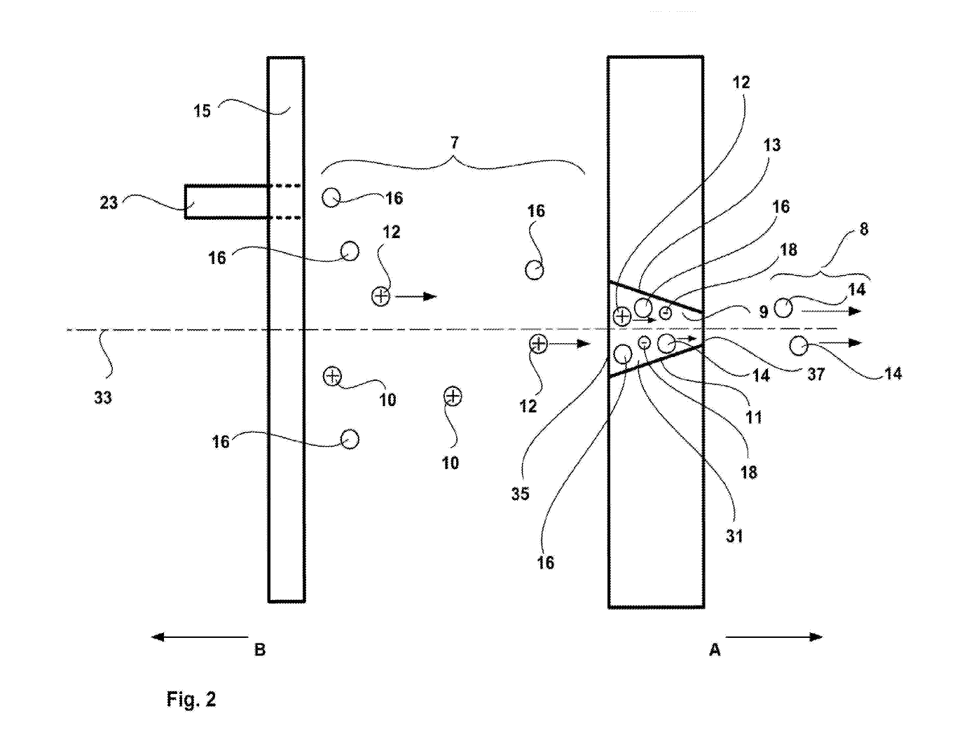

The operation of the thruster 1 will now be described with reference to FIG. 2 which shows an enlarged section of the thruster 1 shown in FIG. 1.

The fluid 7 is introduced into the chamber 5 via a fluid inlet 23 as gaseous neutral particles 16. The voltage differential provided between the first and second electrodes 13, 15 (so that they become cathodes and anodes respectively) cause at least some of the gaseous neutral particles 16 to ionise to plasma ions 12. The ions 12 are positively charged and are accelerated in a direction from the second electrode 15 (being an anode) towards the first electrode 13 (being a cathode). This is shown as accelerated ions 12. Since the first electrode 13 is at least part of the converging section 11 of the nozzle 9, the accelerated ions 12 move towards the region of the converging section 11.

The converging sections 11 operate to restrict particles to freely flow from the chamber 5. This configuration firstly facilitates maintenance of pressure inside the chamber 5 by reducing the path that particles, including neutral particles 16, that may exit the chamber 5. Secondly, the converging sections 11 channel the accelerated ions 12 in a path towards the nozzle axis 33. The effect of this is to increase the probability of neutralisation of the accelerated ions 12 by undergoing charge exchange with neutral particles 16 in the flow path of the accelerated ions 12. This may also increase the probability of neutralisation of the accelerated ions 12 by receiving secondary electrons 18.

Furthermore, the converging section 11 including the first electrode 13 facilitates generation of an electric field for acceleration of the ions. The converging section 11 generates an electric field directed along a nozzle axis 33 from a relatively wider inlet 35 to a narrower outlet 37, which results in the acceleration of the ions along the nozzle axis 33 in direction A. Some ions may also be accelerated in the chamber 5, but the electric field (for example in the area halfway between the second electrode 15 and first electrode 13) may not be as strong as the electric field in the converging section 11 as discussed above.

The velocity of the accelerated ions 12 may depend on a number of factors. One factor is the strength of the electric field that the accelerated ion 12 is exposed to. Secondly, the velocity is also a function of time. Accelerated ions 12 that are relatively closer to the second electrode 15 would have a lower velocity in direction A as these ions have been exposed to a weaker electric field and for a shorter duration of time. This in contrast with the velocity of accelerated ions 12 that are in the converging section 11 that may have had the benefit of acceleration from travelling across the chamber 5 (such as from the second electrode 15 up to entering the converging section 11) as well as the relatively higher electric field in the converging section 11.

The probability of neutralisation of an accelerated ion 12 by charge exchange with a neutral particle 16 increases with the velocity of the accelerated ion 12. Since the accelerated ions 12 in the converging section 11 generally have a higher velocity than the accelerated ions 12 generally in the chamber 5, the probability of neutralisation in the converging section 11 is higher.

It is to be appreciated that although the probability of charge exchange may increase with higher velocity, this probability may reach a maximum at a particular velocity and this may be different for different ionised fluids. Therefore the design of the thruster 1, including the geometry of the converging section, chamber dimensions, voltages and electric fields may need to be adjusted to suit the characteristics of the fluid.

The accelerated ions 12 that have been neutralised become neutral exhaust particles 14 that travel generally in direction A. It is to be appreciated that in some embodiments, not all of the accelerated ions 12 may be neutralised when they are exhausted from the nozzles 9.

### The Chemical Equations

An example of the chemical equations during neutralisation will be described below. In this example, the fluid 7 is hydrogen.

During a first charge exchange, an accelerated ion 12 (denoted as H+) undergoes charge exchange with a neutral hydrogen molecule (denoted as H₂) as shown in Equation 1.

H⁺+H₂--->H*+H₂⁺ (Equation 1)

The result on the right hand side of the equation is that the accelerated ion 12 is neutralised to become a neutral atom (denoted as H*) and exhausted as neutral exhaust particle 14. The former neutral hydrogen molecule on losing a negative charge becomes a positively charged particle (denoted as H₂⁺). This new positively charged particle (H₂⁺) may then undergo the process of acceleration towards the first electrode 13 and neutralisation as discussed below.

The new positively charged particle (H₂⁺) is accelerated toward the first electrode 13 and may undergo a second charge exchange with a neutral hydrogen molecule (H₂). A chemical equation of this neutralisation is provided below in Equation 2.

H₂⁺+H₂--->H₂⁺H₂⁺ (Equation 2)

The result at the right hand side of this equation is that the accelerated hydrogen molecule is neutralised (denoted as H₂*) which may then be exhausted as neutral exhaust particle 14. The former neutral hydrogen molecule (H₂) on the left hand side of the equation becomes a positively charged and may itself be accelerated and neutralised as discussed above.

As discussed above, some of the accelerated ions 12 (denoted as H+) may be neutralised by electrons (denoted as e⁻), such as secondary electrons, that are in the flow path of the accelerated ions 12. This may be shown by Equation 3 below.

H+₊e⁻--->H* (Equation 3)

The result at the right hand side of this equation is that the accelerated ion 12 is neutralised to provide a neutral exhaust particle 14 (denoted as H*).

Similarly a positively charged hydrogen molecule (H₂⁺) may also be neutralised by an electron according to Equation 4 below.

H₂⁺+e⁻--->H_{2*} (Equation 4)

The result at the right hand side of this equation is that the hydrogen molecule is neutralised (denoted as H₂*) which may then be exhausted as neutral exhaust particle 14.

### Design Considerations

One design consideration is maintaining pressure in the chamber 5. Providing the converging section 11 reduces the likelihood of particles that have not been accelerated from leaving the chamber 5. Maintaining the pressure also increases the density of neutral particles 16 in the chamber and in nozzle apertures 31 that are defined by the converging section 11 and consequently the likelihood of the accelerated ions 12 to be neutralised by charge exchange with the neutral particles 16.

However, another consideration is that a higher pressure may increase the chance of collisions of the accelerated ions 12 and/or the neutral exhaust particles 14 with other particles in the flow path. Such collisions may reduce the velocity of the accelerated ions 12 and/or the neutral exhaust particles 14 in direction A, which may reduce the thrust generated by the thruster 1.

Furthermore, providing converging sections 11 so that the accelerated ions 12 are directed towards a plurality of narrower outlets 37 of the nozzle apertures 31 may increase the velocity of the accelerated ions 12 compared to an alternative configuration where the nozzle apertures 31 are cylindrically shaped. The increase in velocity may increase the likelihood (i.e. cross-section) of the accelerated ions 12 undergoing charge exchange with neutral particles 16 in the flow path.

Another consideration is that in at least some instances, a change in geometry of the nozzle apertures 31 may result in a corresponding reduction in likelihood that an accelerated ion 12 would undergo charge exchange with neutral particles 16. A change in geometry of the nozzle 9, in particular the converging section 11, will result in a change in the spatial distribution of the electric field that is generated inside the converging section 11. This in turn will affect the distance over which the ions are accelerated and the number of charge exchange events that may occur. Similarly, a reduction in the distance between the first and second electrode 13, 15 may also reduce the likelihood of an accelerated ion 12 undergoing charge exchange with neutral particles 16 as the accelerated ions 12 would travel a shorter distance and hence pass by fewer neutral particles 16 in the flow path.

In light of at least some of the above mentioned considerations, the thruster 1 may be designed in accordance with the following formula:

P=K/D (Equation 5)

where
P is the pressure inside the chamber in milliTorr;
D is the distance between the first and second electrodes in millimetres; and
K is a constant between 200 and 200000 milliTorr mm.

In some embodiments, it may be desirable to have a constant (K) around 6000 milliTorr mm. A constant (K) of 6000 milliTorr mm may be suitable for a fluid 7 that includes hydrogen (H₂).

However, it is to be appreciated that other constants (K) may be suitable depending on other factors including fluid 7 composition, voltage applied to the electrodes 13, 15 and/or shape and configuration of components of the thruster 1.

A further and/or an alternative consideration is a minimum distance between the first electrode 13 and the second electrode 15 which may affect the electrostatic field in the chamber 5. In one embodiment the distance between the first electrode 13 and the second electrode 15 is at least about 20 millimetres. In further embodiments, the distance between the first and second electrodes 13, 15 may be at least about 25 millimetres or more. In some embodiments the distance between the first and second electrodes 13, 15 is in the range of about 20 to about 100 millimetres. The chamber 5 may have a width in the range of about 10 to about 50 millimetres. In one example, the chamber width is about 30 millimetres.

The voltage potential provided between the first and second electrodes 13, 15 should be at a level that ionises the selected fluid 7 and provides acceleration of the accelerated ions 12. The voltage required may also be dependent on the other design considerations, such as the distance between the first and second electrodes 13, 15 and the respective materials. In one embodiment, the voltage potential is in the range of 1.0 to 5 kV. In a further embodiment, the voltage potential is in the range of about 1.0 to 2.0 kV. In an alternative embodiment, the voltage potential is in the range of about 2.0 to 4.9 kV.

The above considerations may provide a thruster 1 in the described embodiments to have a flow rate of fluid through the thruster 1 in the range of about 0.2 to 6 standard cubic centimetres per minute. In some embodiments, the flow rate is less than 1 standard cubic centimetres per minute.

However it is to be appreciated that the thruster 1 may be scaled to smaller or larger sizes that include corresponding changes in dimensions, voltages, configurations and/or flow rates.

### Description of a First Embodiment

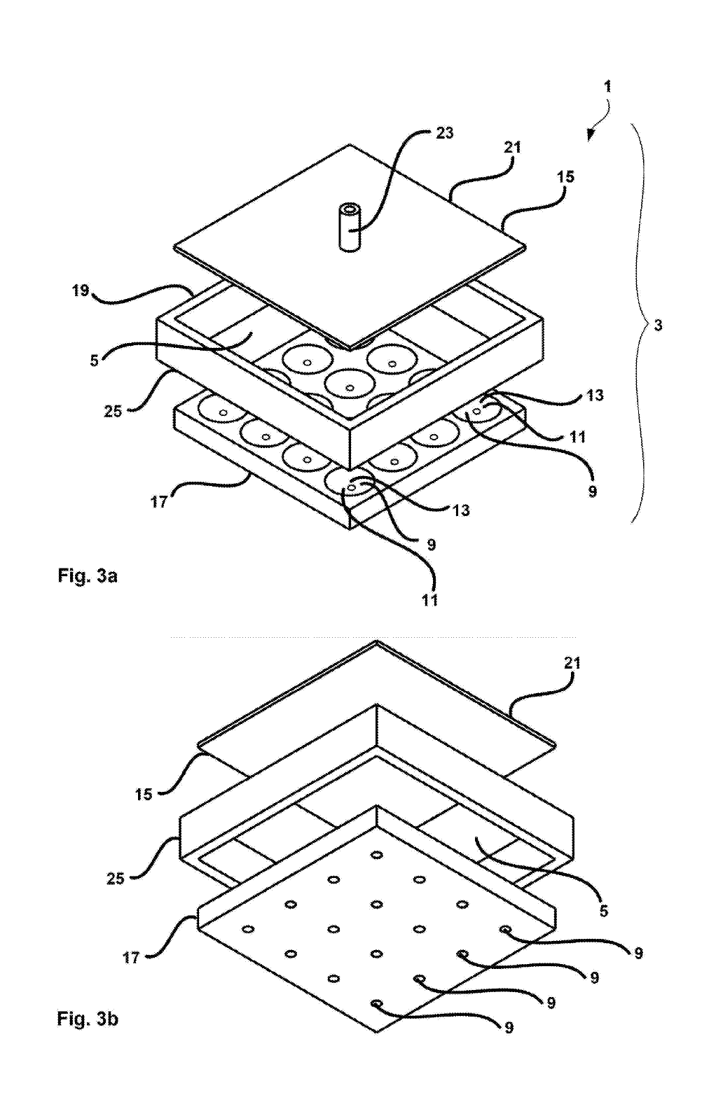

The thruster 1 according to a first embodiment will now be described with reference to FIGS. 3 to 5, 12 and 15.

### Enclosure 3

Referring to FIGS. 3a and 3b, an enclosure 3 that defines the chamber 5 includes three main components: a nozzle element 17, a spacer 19 and a cover 21. The nozzle element 17 is disposed at a first end of the enclosure 3 and the cover 21 is at a second end of the enclosure and with the spacer 19 substantially there between.

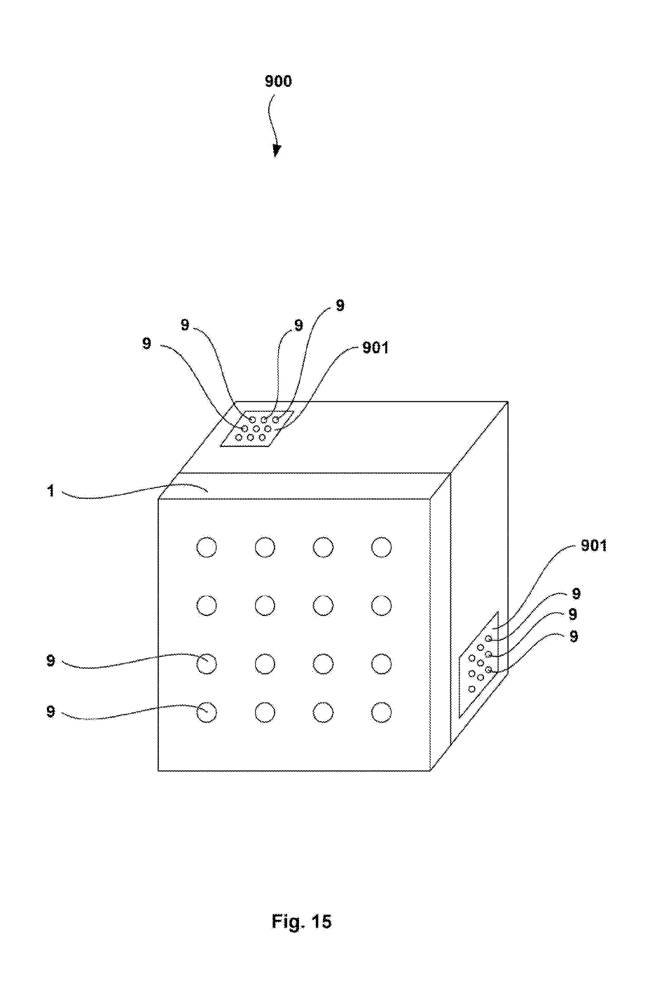

When assembled, these components form the enclosed chamber 5. A fluid inlet 23 allows fluid 7 to enter the chamber 5, in which the fluid 7 is ionised and the ions accelerated, and the nozzles 9 allow particles 8 to be exhausted from the chamber 5 to provide thrust. A plurality of thrusters 1, as shown in FIG. 15, could be used on a space vehicle to provide thrust in various axes or to generate torque. For example, the thrusters 1 could be used individually or in combination to achieve attitude manoeuvres.

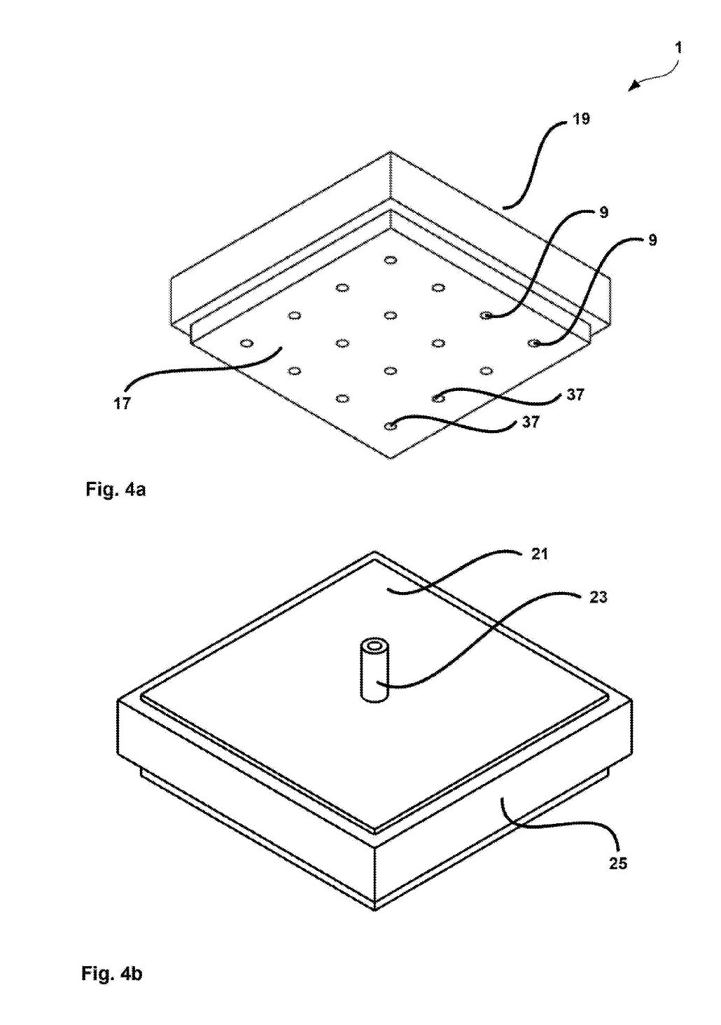

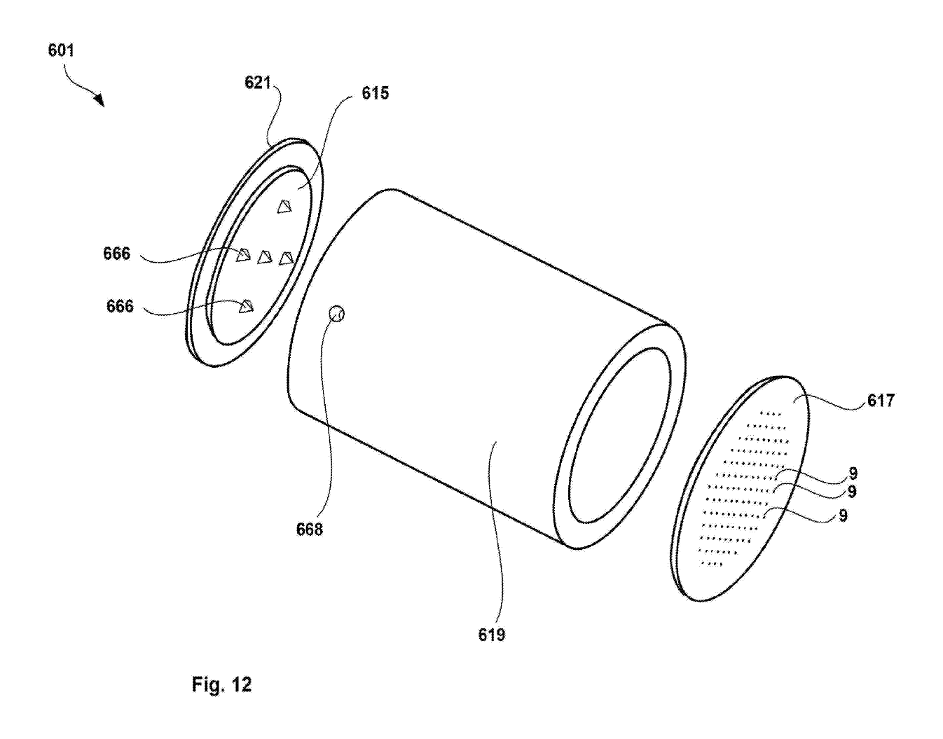

One consideration for the shape of the enclosure 3 may include maximising the use of space or other spatial considerations in the application of the thruster 1. The thruster 1 shown in FIG. 4 has an enclosure 3 that is a substantially rectangular cuboid. This configuration may provide a compact configuration to maximise the use of space. For example, the thruster 1 may be used in a satellite 900 having a substantially rectangular cuboid shape, as illustrated in FIG. 15, and providing an enclosure 3 of a substantially rectangular cuboid may maximise the use of space in the satellite. However it is to be appreciated that in some alternatives, the enclosure 3 may have other shapes. For example, the enclosure 3 may have a substantially cylindrical shape as illustrated in FIG. 12.

### The Cover 21

The cover 21 forms part of the perimeter at the second end of the enclosure 3 to define the chamber 5. The cover 21 encloses at least part of the chamber 5 to prevent unwanted leakage of the fluid 7 from the chamber 5. This is important in use to maintain pressure of the fluid 7 inside the chamber 5.

Furthermore, the cover 21 includes the second electrode 15 at the side of the cover 21 facing the chamber 5. In the illustrated embodiment, the second electrode 15 and cover 21 are substantially planar and oppose the first electrodes 13 at the other end of the enclosure 3. For a cuboid chamber 5 of fixed dimensions, this configuration maximises the distance between the first and second electrode 13, 15.

The cover 21 may be formed of an electrically conductive material so that a surface of the cover 21 forms the second electrode 15. A conductive material for the cover 21 may include titanium, aluminium or gold.

In one alternative embodiment, the cover 21 may include a first substrate (of one or more of a conductive, non-conductive, or semi-conductive material) and a second substrate of conductive material whereby the second substrate faces the chamber 5 to form the second electrode. The first substrate may include a ceramic material, silicon, glass, etc. A conductive material for the second substrate may include doped silicon, titanium, aluminium and gold. Such conductive material may include silicon gold alloy. In yet another embodiment, the second electrode 15 may be a separate component from the cover 21.

The cover 21 also includes a fluid inlet 23, which is in the form of an aperture fluidly connected to an inlet pipe. The fluid inlet 23, which is provided proximal to the second electrode 15 supplies fluid 7 to be ionised and accelerated. Providing the fluid 7 proximal to the second electrode 15 may provide a longer path for acceleration of ions from the second electrode 15 to the first electrode 13, thereby providing greater impulse to the ions and resulting in greater velocity of the particles 8. This may result in a greater chance of the accelerated ions 12 to be neutralised. It is to be appreciated that more than one fluid inlet 23 may be provided and that in alternative embodiments the fluid inlet 23 may enter the chamber through other components of the enclosure such as through the spacer 19.

### The Spacer 19

The spacer 19 also forms part of the perimeter of the enclosure 3 to define the chamber 5 and maintain pressure within the chamber 5. The spacer also functions to separate the nozzle element 17 (having the first electrode 13) and the cover 21 (having the second electrode 15). The spacer 19 may be provided such that the length of the chamber 5 from the first electrode 13 to the second electrode 15 is at least 20 mm, or alternatively 25 mm or greater. In some embodiments the chamber has a length in the range of 20 to 100 millimetres and a width in the range of 10 to 50 mm. It is to be appreciated that these dimensions are in accordance with some embodiments and that other dimensions may be considered.

To provide ionisation and acceleration, a voltage difference is provided between the first electrode 13 and the second electrode 15. Therefore it is important to provide good electrical insulation between the first electrode 13 and the second electrode 15. This is facilitated by providing a spacer 19 made of non-conductive material. Non-conductive material may include one or more of: SiNx, SiO₂, ceramic, polytetrafluoroethylene, or other polymers.

As shown in FIGS. 3a and 3b, the spacer 19 includes four chamber walls 25 surrounding the chamber 5. However it is to be appreciated that other configurations of the spacer 19 may be suitable, for example a cylindrical side wall surrounding the chamber 5 as shown in FIG. 12.

### The Nozzle Element 17

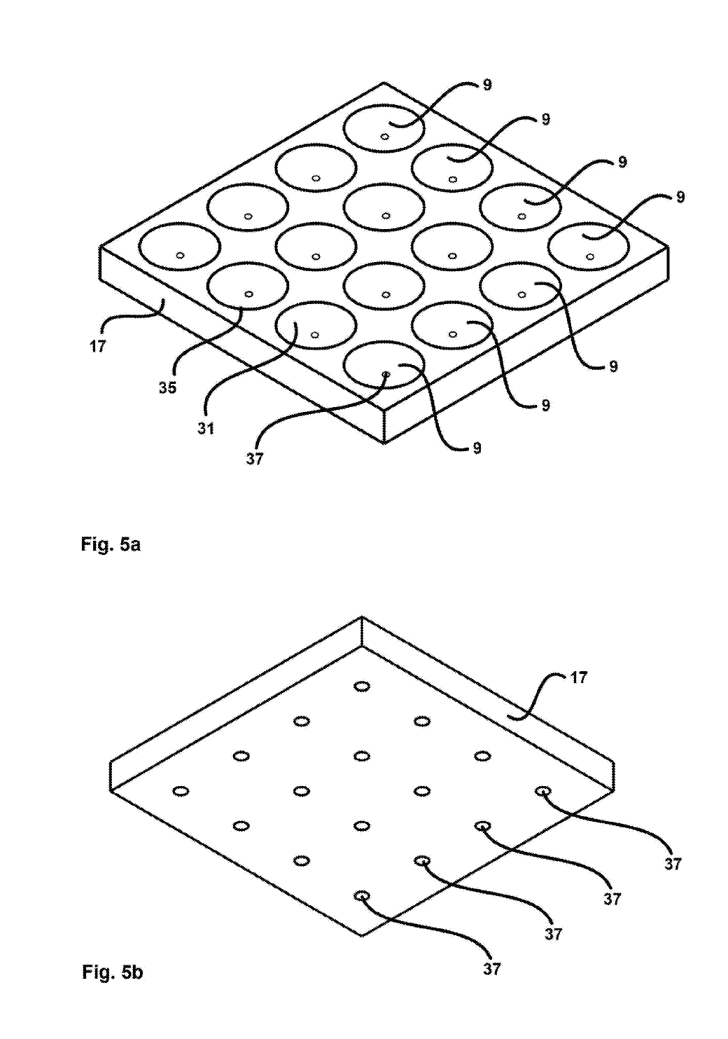

The nozzle element 17 will now be described with reference to FIGS. 3 and 5. The nozzle element 17 is substantially planar and includes a plurality of nozzles 9 arranged in an array. The nozzles 9 may be arranged in a two-dimensional array with regular spacing between each of the nozzles. In some embodiments, regular spacing may assist in providing predetermined thrust characteristics or assist in calculation of thrust characteristics. In alternative embodiments, the plurality of nozzles 9 may be arranged with irregular spacing between nozzles. The plurality of nozzles 9 may be arranged to provide specified thrust characteristics. For example, one or more of the plurality of nozzles 9 may have a nozzle axis 33 that is different to another nozzle to impart a spin on the object having the thruster 1.

In FIG. 5 the nozzle element 17 includes sixteen nozzles 9 in a four-by-four array. In some embodiments the number of nozzles 9 in the plurality of nozzles is in the range of 3 to 1000. In some further embodiments the number of nozzles 9 in the plurality of nozzles is in the range of 10 to 1000.

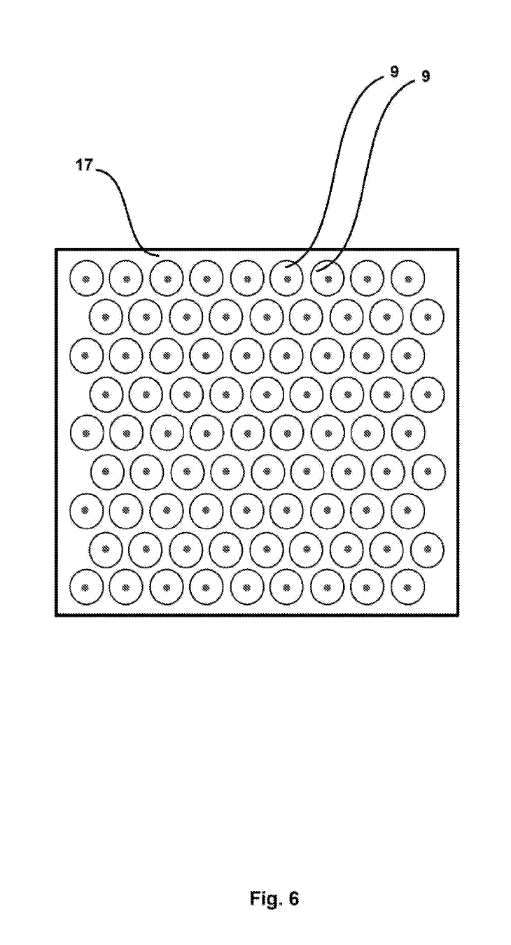

In some embodiments, the nozzles 9 are arranged in predetermined circle packing patterns (e.g. triangular tiling as shown in FIG. 6) to provide maximum density of nozzles 9 for the surface of the planar nozzle element 17. However, it is to be appreciated that in other embodiments, the configuration of the plurality of nozzles may be in alternative patterns.

The nozzle element 17 may be formed of an electrically conductive material having the plurality of nozzles 9, whereby at least part of the nozzle elements 17 form the at least one electrode 13. In an alternative embodiment, the nozzle element 17 includes a substrate formed from one or more of a conductive, non-conductive or semi-conductive material and further including an electrically conductive lining at the converging section 11 of the nozzles to form the first electrode 13.

In the embodiment illustrated in FIGS. 3a and 3b, the entire chamber facing surfaces of nozzle element 17 may form a cathode. However, in some embodiments, only the converging section 11 (or part of the converging section 11), form a cathode. This is discussed below in the some of the other embodiments where parts of the cathode forming structure are masked to limit exposure of the cathode to the converging section 11.

### The Nozzles 9

The nozzles 9 will now be described with reference to FIGS. 1 and 5. Generally, each nozzle 9 has a nozzle aperture 31 formed by an inlet 35 that converges to a relatively narrower outlet 37 by the converging section 11. This constricts the flow of particles from the chamber 5 and assists in maintenance of pressure inside the chamber 5.

In the illustrated embodiment, each nozzle 9 has a nozzle aperture 31 with a frustoconical shape. Each nozzle aperture 31 has a nozzle axis 33 and extends from an inlet 35 (at the chamber side) to an outlet 37 (at the exhaust side). The inlet 35 and outlet 37 may be substantially circular. Between the inlet 35 and the outlet 37 is the converging section 11 which in this case is a generally conical surface that converges towards the nozzle axis 33 from the inlet 35 to the outlet 37.

In some embodiments, conical surface of the converging section 11 has a generator angle of between 5 and 45 degrees from the nozzle axis 33 of the nozzle aperture 31. In some further embodiments the generator angle is between 5 degrees and 45 degrees.

In some embodiments, the inlet 35 may have an inlet diameter of between 1 to 20 millimetres. In some further embodiments, the inlet diameter may be between 0.5 and 4 millimetres. The circular outlet 37 may have an outlet diameter of between 0.1 and 8 millimetres. In some further embodiments, the outlet diameter may be between 0.1 and 0.8 millimetres. In some embodiments, the distance between the inlet 35 and the outlet 37 along the nozzle axis is in the range of 1 to 20 millimetres. In some further embodiments, the distance between the inlet 35 and the outlet 37 along the nozzle axis is in the range of 5 to 20 millimetres.

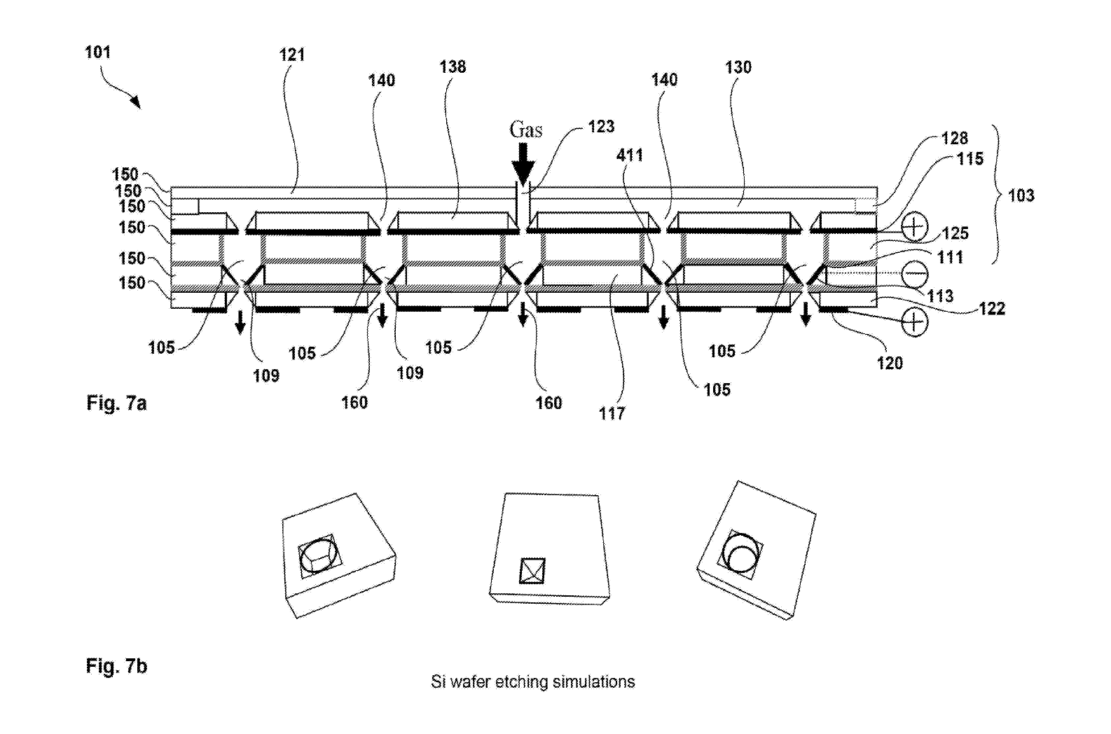

It is to be appreciated that in some other embodiments, the nozzles apertures 31 may be defined by inlets 35, outlets 37 and converging sections 11 in different configurations. In one example, the converging sections 11 may be formed of a plurality of planar surfaces that converge towards the nozzle axis 33 from the inlet 35 to the outlet 37 to form a nozzle aperture in the shape of a frustum of a pyramid as illustrated in FIG. 7. Such pyramid shapes may include triangular pyramids, square pyramids, rectangular pyramids, hexagonal pyramids, etc. In yet other embodiments, the converging sections 11 may include a curved surface where a cross-section in a plane through the centre axis 33 provides a converging section 11 edge with a curve.

### Description of a Second Embodiment

Another embodiment of a thruster 101 will now be described with reference to FIGS. 7a and 7b. In this embodiment the thruster is constructed from multiple layers of silicon wafers 150 processed by wet etching (as illustrated in FIG. 7b), lithography and thin film coating. Techniques for creating such multiple layers may include techniques the same as, or similar to, those used in the semiconductor industry. The layers of silicon wafers 150 may be bonded together with epoxy.

Referring to FIG. 7a, the thruster 101 includes a plurality of chambers 105, where each chamber 105 is provided with a respective nozzle 109. FIG. 7a shows a cross section of the thruster 101 with multiple nozzles arranged in a row. However, it is appreciated that additional nozzles may be provided so that the thruster 101 may include an array of nozzles as described above. The thruster 101 is constructed from multiple layers that will now be described in order.

A first cover layer 121 includes an aperture to form a common fluid inlet 123. An intermediate chamber layer 128 provided at the outer perimeter of the enclosure 103 forms an intermediate fluid chamber 130. The intermediate fluid chamber 130 aids distribution of the fluid 7 to the multiple chambers 105. The next layer is a fluid inlet layer 138 provided with multiple apertures to form individual fluid inlets 140 for each of the plurality of chambers 105. The apertures forming the individual inlets 140 may be etched, as illustrated in FIG. 7b, to form apertures having a shape of a frustum of a square pyramid. It is to be appreciated that alternatively, other aperture shapes may be used, such as a frustoconical shape, a cylindrical shape, rectangular shapes, etc.

The next layer is an anode layer 115. This layer may be formed of a conductive material such as titanium, aluminium, copper, gold, doped silicon, etc. The anode layer 115 provides the second electrode that is in communication with the chamber 105 and functions similarly to the second electrode 15 described above.

The next layer is a spacer layer 125 that includes a plurality of apertures to form the plurality of chambers 105. The apertures may be rectangular, circular, or other shapes. The spacer layer 125 may function to electrically insulate the second electrode layer to the first electrode 113 (discussed below). Therefore the spacer layer 125 may be constructed of a functionally electrically non-conductive material.

The next layer is a nozzle layer 117. The nozzle layer 117 includes a plurality of apertures that are defined by converging surface(s). The apertures may be shaped as a frustum of a pyramid or have a frustoconical shape. The nozzle layer 117 is provided with a cathode layer 113 that forms an electrode functionally similar to the first electrode 13 described above. The cathode layer 113, which overlies the surfaces of the apertures in the nozzle layer 117, also forms the converging sections 111 that define the apertures 109 and are functionally similar to the converging sections 11 that define apertures 9 described above.

The next layer is an end layer 122 that includes a plurality of apertures 160. The apertures 160 allow passage for the particles 8 to be exhausted from the chamber 105. The apertures 160, in this embodiment, include diverging surface(s). Similar to the nozzles 9, the apertures 160 may be shaped as a frustum of a pyramid, a frustoconical shape, etc. However, it is to be appreciated that alternative embodiments may include other shapes such as a cylindrical or square bore.

The next layer is a second anode layer 120 that forms a third electrode. The second anode layer 120 includes a plurality of apertures to allow particles 8 to exhaust from the thruster 101. The second anode layer 120 may be provided with a voltage differential (to the cathode) so that electrons may be attracted to the region of the flow of particles 8. In some embodiments, not all particles 8 that pass through the apertures 109 and the nozzle layer 117 are neutralized. The second anode layer 120, by attracting electrons may facilitate providing electrons in the path of the particles 8 so that accelerated ions 12 (or other positively charged particles) may be neutralized.

In one embodiment, the second anode layer 120 may attract secondary electrons.

### Description of a Third Embodiment

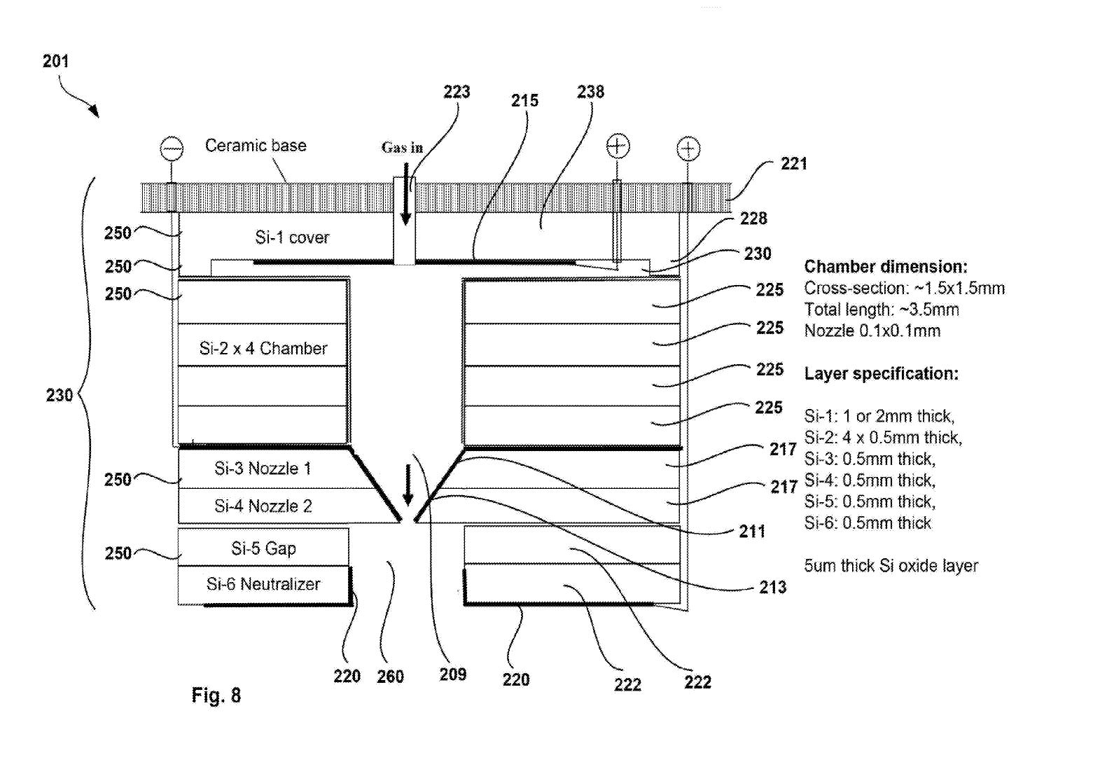

FIG. 8 illustrates a third embodiment of a thruster 201. FIG. 8 illustrates one chamber 205 and nozzle 209 to improve clarity. It is to be appreciated that in this embodiment, multiple chambers 205, nozzles 209 and other relevant features may be provided on the layers so that the thruster 201 includes a plurality of nozzles, including an array arrangement as discussed above. The thruster 201 is constructed from multiple layers that will now be described in order.

The first layer is a cover layer 221 constructed of a ceramic material. The cover layer 221 may be the first layer that forms a base on which subsequent layers 250 of silicon, or other material, is fabricated on. The cover layer 221 includes an aperture to provide a fluid inlet 223.

The next layer is a fluid inlet layer 238 with a passage to allow communication with the chamber 205. The next layer is the anode layer 215 that provides the second electrode. The next layer is an intermediate chamber layer 228 that is provided at the outer perimeter of the enclosure 203 to form an intermediate chamber 230. As illustrated in FIG. 8 the intermediate chamber 230 is substantially wider than the chamber 205. The intermediate chamber 230 also accommodates the large anode layer 215. This configuration may provide greater surface area for the anode layer 215 to be in contact with the fluid 7 in the intermediate chamber 230.

The next layers are the spacer layers 225, similar to the spacer layers described above that include apertures to form the chamber 205. The spacer layers 225 may be made of silicon wafers stacked on each other. In one embodiment, the layers provide a chamber length in the range of 20 to 35 millimetres. The apertures in the spacer layers 225 may provide chambers with a width of approximately 1.5 millimetres.

The next layer is a cathode layer 213, which overlies the surfaces of the apertures in a nozzle layer 217. The cathode layer 213 forms the converging sections 211 that define the apertures 209 and are functionally similar to the converging sections 11 described above. The cathode layer 213 is, in part, sandwiched between the spacer layer 225 and nozzle layer 217 to reduce the cathode layer 213 from being exposed. This may reduce the chance of charged particles from being inadvertently attracted or repelled by the cathode layer 213.

The next layer is a nozzle layer 217. The nozzle layer 117 includes an aperture that is defined by converging surface(s). The apertures may include various shapes as described above. The small exit diameter of the apertures in the nozzle 209 may have a width of approximately 0.1 millimetres.

The next layers are end layers 222 that include an aperture 260. The aperture 260 allows passage for the particles 8 exhausted from the chamber 205. The apertures 160, in this embodiment, include a bore with a straight surface, although alternatives such as the other shapes described above may be used.

The next layer is a second anode layer 220. In this embodiment, the second anode layer covers at least part of the bore of the aperture 260. The second anode layer 220 may function similar to the second anode layer 120 described above to neutralize positively charged particles. The second anode layer 220, by covering at least part of the bore of the aperture 260 may provide improved attraction of electrons in the area of the aperture 250.

In one embodiment, the minimum distance between the cathode layer 213 and the second anode layer is approximately 0.5 millimetres.

One or more layers 250 may include silicon wafers. The silicon wafers may have a thickness in the range of 0.5 to 2 millimetres thick. The layers of silicon may also be oxidised on the surface to provide insulation. In one example, the silicon oxide layer is around 5 micrometres thick.

### Description of a Fourth Embodiment

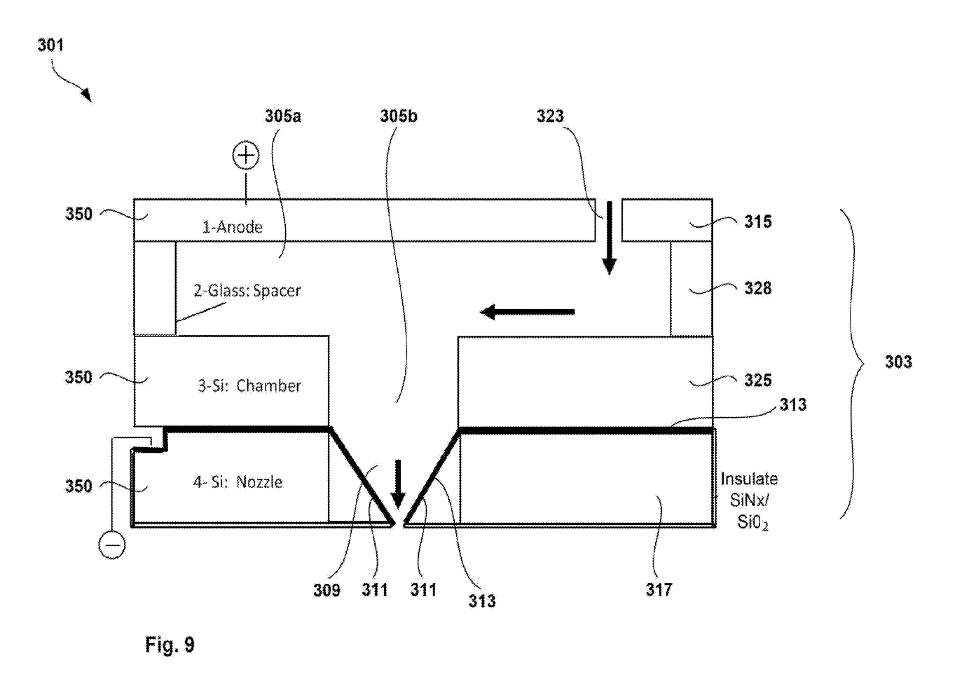

FIG. 9 illustrates a fourth embodiment of a thruster 301. In this embodiment, the thruster 301 includes a common chamber 305a that leads to a plurality of individual chambers 305b for each respective nozzle 309. FIG. 9 illustrates one individual chamber 305b and nozzle 309 that is fluidly connected to the common chamber 305a. However, it is to be appreciated that thruster 301 includes a common chamber 305a that leads to multiple individual chambers 305b and respective nozzles 309 which may be arranged in an array as discussed above.

The thruster 301 is constructed from multiple layers 350 that will now be described in order.

The first layer is an anode layer 315 that provides the second electrode and also functions to cover the end of the enclosure 303. The anode layer 315 includes an aperture to for a fluid inlet 323.

The next layer is a spacer 315 to provide a volume of a common chamber 305a. The spacer 315 may be made of a non-conductive material such as glass.

The next layer is a spacer layer 325 that includes apertures to form respective individual chambers 305b. In this embodiment, the aperture in the spacer layer 325 is smaller than the width of the common chamber 305a at the glass spacer 315. The spacer layer 325 may be made of a non-conductive material. In one embodiment, the spacer layer 325 is made of one or more layers of silicon wafers.

The next layer is a cathode layer 313, which overlies the surfaces of the apertures in a nozzle layer 317. The cathode layer 313 forms the converging sections 311 that define the apertures 309 and are functionally similar to the converging sections 11 described above. The cathode layer 313 is, in part, sandwiched between the spacer layer 325 and nozzle layer 317.

The arrangement of the spacer 315 and the spacer layer 525 may provide a combined chamber length of the common chamber 305a and individual chambers 305b to be longer. In one example the combined chamber length may be up to and including 110 millimetres.

### Description of a Fifth Embodiment

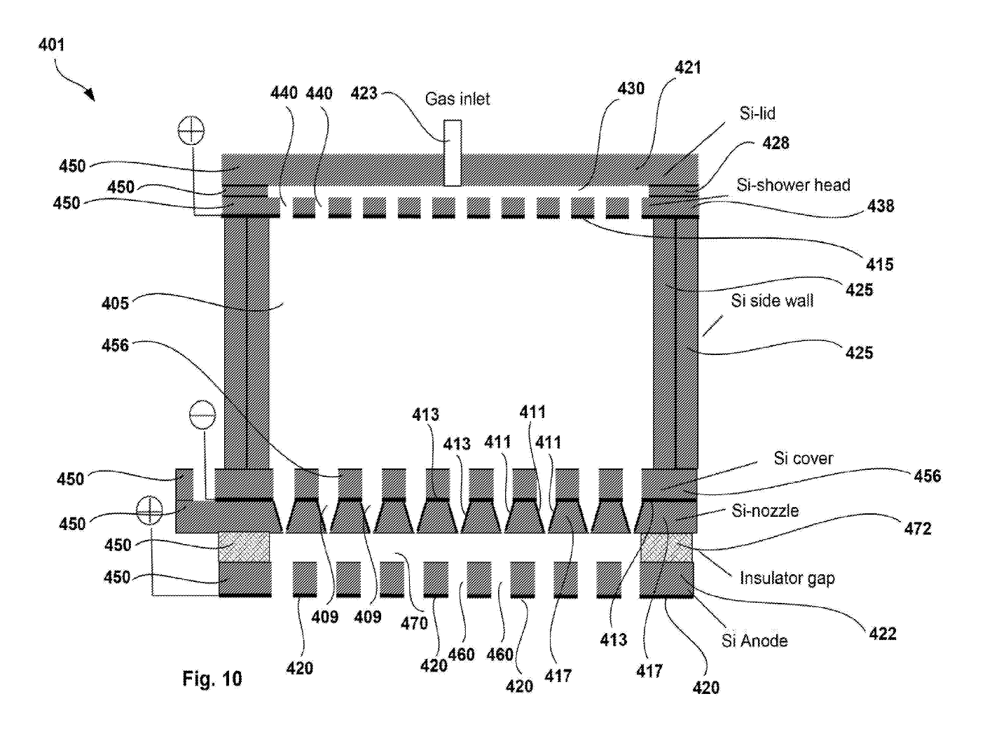

FIG. 10 illustrates a fifth embodiment of a thruster 401 that includes multiple layers 450. In this embodiment, the thruster 401 includes a chamber 405 that is fluidly connected to a plurality of nozzles 409. A common fluid inlet 423 is fluidly connected to an intermediate fluid chamber 430. The intermediate fluid chamber 430 leads to a plurality of individual fluid inlets 440 that in turn distribute fluid entering the chamber 405.

The plurality of individual fluid inlets 440 may improve distribution of fluid 7 into the chamber 405. In particular, this may assist uniform distribution to allow uniform plasma formation and thrust through the nozzles 409. This may be advantageous for thrusters with a larger array of nozzles 409, such as those with an array larger than 60 by 60 millimetres.

The thruster 401 is constructed from multiple layers 350 that will now be described in order.

The first layer is a cover layer 421 that includes an aperture to form a common fluid inlet 423. This is followed by an intermediate chamber layer 428 that defines the intermediate chamber 430. The next layer is a fluid inlet layer 438 which is provided with a plurality of apertures that form a plurality of individual fluid inlets 440 to allow the flow of fluid 7 into the chamber 405. The fluid inlets 440 may be arranged in various patterns, including arrays, to achieve a desired distribution. The fluid inlet layer 438 may be made of a non-conductive material to mask at least part of the adjacent anode layer 415 discussed below. The masking of the anode layer 415 may reduce the chance of the anode layer 415 inadvertently influencing particles in the intermediate fluid chamber 430.

The next layer is the anode layer 415 that includes a plurality of apertures to facilitate flow of fluid from the intermediate chamber 430 to the chamber 405. The anode layer 415 is functionally similar to the second electrode described above.

The next layer is the spacer layer 425 provided to form the chamber 405. The spacer layer 425 may be made of a non-conductive material. In one embodiment the spacer layer 425 includes a double side wall made of silicon.

The next layer is a cathode mask layer 456 that includes a plurality of apertures each leading to respective nozzles 409. The cathode mask 456 layer is made of a non-conductive material and is provided to mask parts of the cathode layer 413 from the chamber 405. In the illustrated embodiment the cathode mask layer 456 masks the cathode layer 413 so that only parts of the cathode layer 314 that form converging sections 411 are exposed to the chamber 405. This configuration may facilitate acceleration of positively charged particles, such as ions 12, 16, towards the nozzles 409.

The nozzle layer 417 includes a plurality of apertures and supports the cathode layer 413 to provide the nozzles 409 similar to the nozzle layers discusses above.

The plurality of nozzles 409 lead to a common exhaust chamber 470. An exhaust chamber layer 472 provides the common exhaust chamber 470. An end layer 422 includes a plurality of apertures to provide a plurality of exhaust apertures 460. In this embodiment, exhaust apertures 460 are provided on the nozzle axis 33 of respective nozzles 9. This facilitates flow of particles from the nozzles 409 through the exhaust apertures 460.

The next layer is the second anode layer 420. The second anode layer 420 may function similar to the second anode layer 120, 220 discussed above to attract electrons for neutralising positively charged particles that may be exhausted through the nozzles 409.

### Description of a Sixth Embodiment

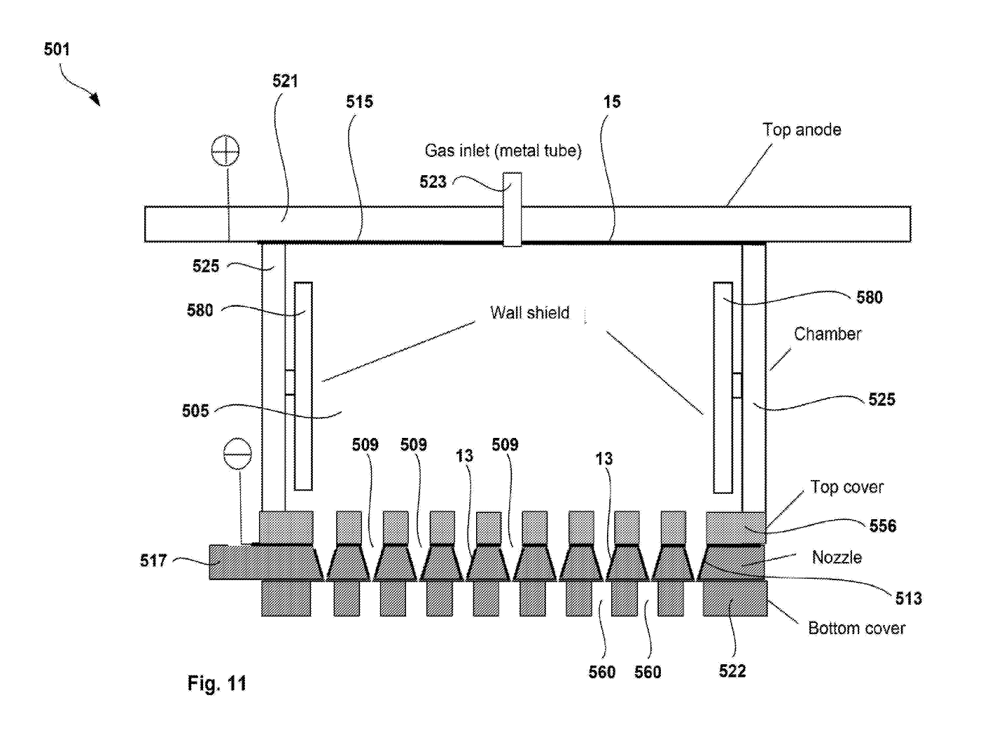

FIG. 11 illustrates a sixth embodiment of the thruster 501. The thruster in this embodiment includes shields 580 adjacent to the walls 525 of the chamber 505.

During operation, some of the accelerated ions 12 may collide with the first electrode 13 (illustrated in FIG. 11 as cathode 513). Such collisions may cause sputtering, whereby the sputtered atoms may coat the walls 525 of the chamber 505 with a conductive layer. A conductive layer on the chamber wall may detrimentally cause leakage current between the first and second electrodes 13, 15 and reduce the power efficiency of the device. Providing shields 580 may prevent or reduce the effects of sputtering by shielding at least part of the wall of the chamber 505 from the sputtered atoms. The walls 525 and the shields 580 are made of a non-conductive material. This may include ceramics, polymers or other non-conductive materials described herein.

The embodiment in FIG. 11 also includes an anode layer 515, cover layer 521, fluid inlet 523, cathode mask layer 556, cathode layer 513, nozzles 509 and nozzle layer 517 similar to those described above. An end layer 522 is provided with a plurality of exhaust apertures 560 for each of the nozzles 509.

The anode layer 515 may be formed of a layer of copper over an aluminium substrate. In one example, this may include a cover layer 521 made of aluminium with a copper anode layer 515. This may include electroplating the copper to the aluminium substrate. The cathode layer 513 may include an aluminium substrate with a layer of titanium coated, plated or otherwise bonded to the aluminium substrate. In one example, this may include a nozzle layer 517 with a titanium cathode layer 513.

FIG. 12 illustrates a variation of the thruster 601 that is substantially cylinder shaped. A spacer 619 includes a substantially tube shaped body wherein the hollow forms the chamber 5. A cover 21 and a nozzle element 617 are substantially disc-shaped and are disposed at the ends of the tubular spacer 619. The inner surface of the cover 621 forms an anode 615 and is made from a conductive material and may contain surface augmentation 666, in the form of pyramid shaped protrusions, to promote the striking of plasma by the creation of a sharp electric field. In some embodiments, the nozzle element 617 may be constructed of aluminium or titanium, doped silicon, silicon gold alloy or other conductive material. The spacer 619 is constructed of an insulate, glass, ceramic, etc. As shown in FIG. 12, an aperture is provided in the side of the spacer 619 to form a fluid inlet 668. The nozzle element 617 may be formed of a conductive material so that the region of the nozzle 9, in particular the converging section, is conductive. The converging section may form a cathode as described above. The nozzles 9 may have a converging section 11 that defines an aperture having a frustoconical shape, with circular outlet having a diameter less than 1 millimetre. A cylindrical ring anode (not shown), functionally similar to the second anode 220 in FIG. 8, may be provided downstream of the nozzles 9.

### Description of a Seventh Embodiment

A seventh embodiment of the thruster includes a nozzle element 717 that is formed by milling a plurality of nozzles 9 from a based material. In one examples, the base material is a block of metal. The metal may include aluminium, titanium, and/or other metals and alloys.

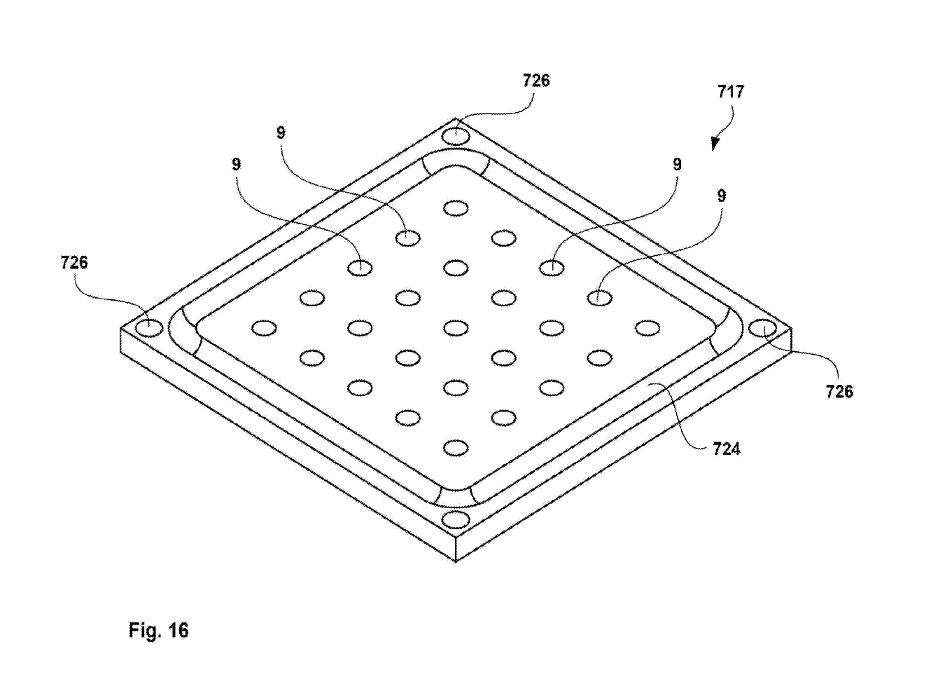

An example of the nozzle element 717 of the seventh embodiment is illustrated in FIG. 16, although it is to be appreciated that it may be in a form similar to those illustrated in FIGS. 3, 5a, and 6. In one example, the nozzle element 17 may be manufactured using a CNC (computer numerical control) machine to mill out material to create the nozzles 9.

The nozzle element 717 also includes a milled channel 724 around the plurality of nozzles 9. In one example, the milled channel 724 may receive a seal, such as an O-ring (not illustrated) made of rubber, silicon or other appropriate material. When the thruster is assembled, the O-ring also contacts the spacer to form a hermetic seal between the spacer and nozzle element 17 when joined.

In some alternatives the nozzle element 717 may be formed by additive manufacturing. This may include 3D printing of the nozzle element 717 or portions thereof. The 3D printed nozzle element 717 may be printed with the features of the plurality of nozzles 9 and or channel 724. In some examples, further manufacturing processes may be used to finish the nozzle element 717 to provide such features. In some examples, the 3D printed nozzle element 717 includes one or more of the base metals described above.

It is to be appreciated that the spacer and the nozzle element may be joined in a number of ways. In one example, the nozzle element and spacer may be fastened to one another by fasteners, such as a bolt. As illustrated in FIG. 16, the nozzle element 717 may have apertures 726 to receive fasteners. In some examples, the spacer and nozzle element may be joined together by bonding, such as with an adhesive, chemical and/or cement.

The insulating spacer 19 may, in some alternatives, be manufactured with additive manufacturing. In some examples, this may include 3D printing of insulating material to form the insulated spacer 19.

### Description of an Eighth Embodiment

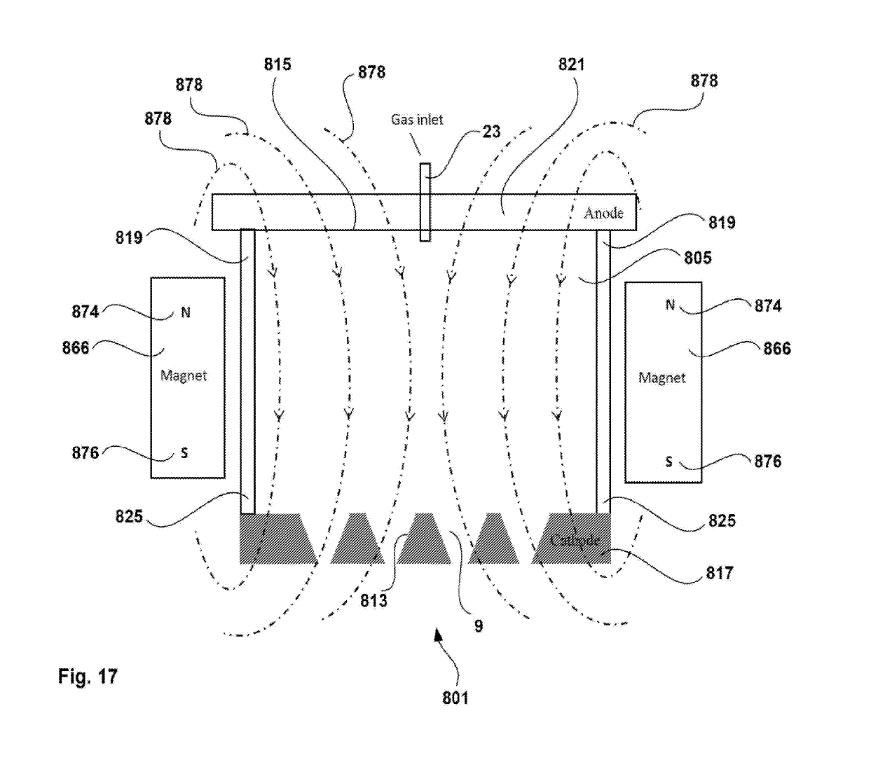

FIG. 17 illustrates an eighth embodiment of the thruster 801. In this illustrated example, the thruster 801 also includes a nozzle element 817 and cover 821 with respective first and second electrodes 813, 815, and a spacer 819. It is to be appreciated that further variations may include features from the other embodiments described herein.

The thruster 801 in this embodiment includes a magnet 866 located outside the walls 825 of the chamber 805. The magnet provides a magnetic field which in part, passes through the chamber, to influence the plasma as described below. It is to be appreciated that other variations may include a magnet located inside the chamber 805.

In one example, the magnet 866 is an annular permanent magnet (e.g. a “ring magnet”) that is located to surround the walls 825 of the spacer 819. Thus the magnet 866 encircles the chamber 805. The magnet includes a north pole 874 and a south pole 876. The magnet 866 provides a magnetic field that is represented by magnetic field lines 878 which, in part, passes through the chamber 805. The magnetic field passes through the chamber 805 approximately along the electric field direction between the anode (in this case the second electrode 815) and the cathode (in this case the first electrode 813). This may assist confining electrons in around the magnetic field inside the chamber 805. This may, in turn, assist in intensifying the plasma density and to produce more ions. This may result is enhanced thrust which, with greater efficiency, may reduce the fluid 7 or rate of fluid that needs to be consumed.

### Fluid System 60

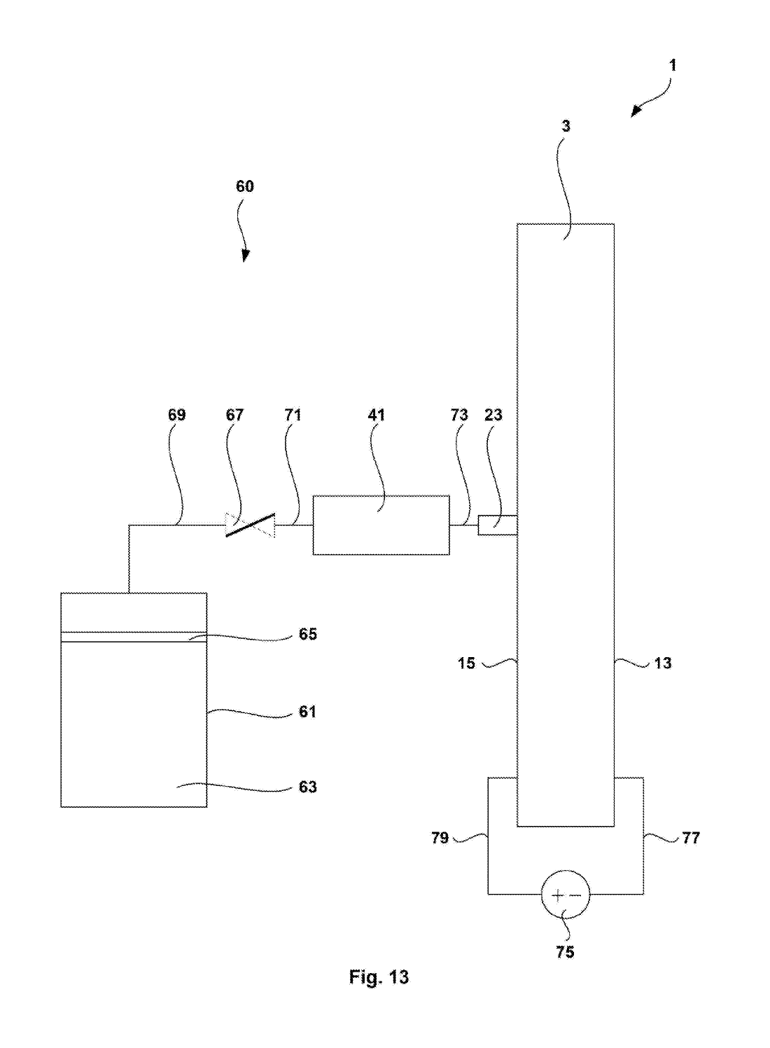

FIG. 13 shows a schematic of the fluid system 60 for supplying fluid 7 to the chamber 5 in the enclosure 3. The fluid system 60 includes a fluid tank 61 that is in fluid communication, via fluid conduits 69, 71, 73, to the fluid inlet 23 of the thruster 1. In between the fluid tank 61 is a valve 67, to allow or stop the flow of fluid 7 and a fluid flow control means 41 to control the flow rate of the fluid 7. It is to be appreciated that the valve 67 could be placed anywhere between the fluid flow path between the fluid tank 61 and the thruster 1.

The fluid 7 in the fluid tank 61 may be stored, in part, in a liquid state. The fluid 7 in the fluid tank 61 may be pressurised relative to the surroundings (either the surrounding atmosphere or the vacuum of space). This pressurisation may be due to the vapour pressure of the liquid fluid 7 and/or the gas pressurisation of gaseous fluid 7. This relative pressurisation of fluid 7 in the fluid tank 61 causes the fluid 7 to flow from the fluid tank 61 to the chamber 5 and subsequently towards the nozzle apertures 31 that leads to the lower pressure surrounding atmosphere or vacuum of space. Thus this configuration may not require a fluid pump to supply the fluid 7 from the fluid tank 61 to the chamber 5. However it is to be appreciated that in alternative embodiments, a fluid pump may be provided to facilitate supply of the fluid 7.

A voltage source 75 is also illustrated which provides the voltage potential to the first and second electrodes 13, 15 by electrical leads 77 and 79 respectively.

### Fluid Flow Control Means 41

Maintaining the pressure in the chamber 5 at a desired level or range of pressures, depends on one or more interrelated factors that may include the flow rate of fluid 7 into the chamber 5, the dimensions and/or shape of the chamber 5, the dimensions and shape of the nozzle apertures 31, the number of nozzles 9, the flow rate of particles 8 out of the thruster 1 and the voltage difference applied to the first and second electrodes 13, 15.

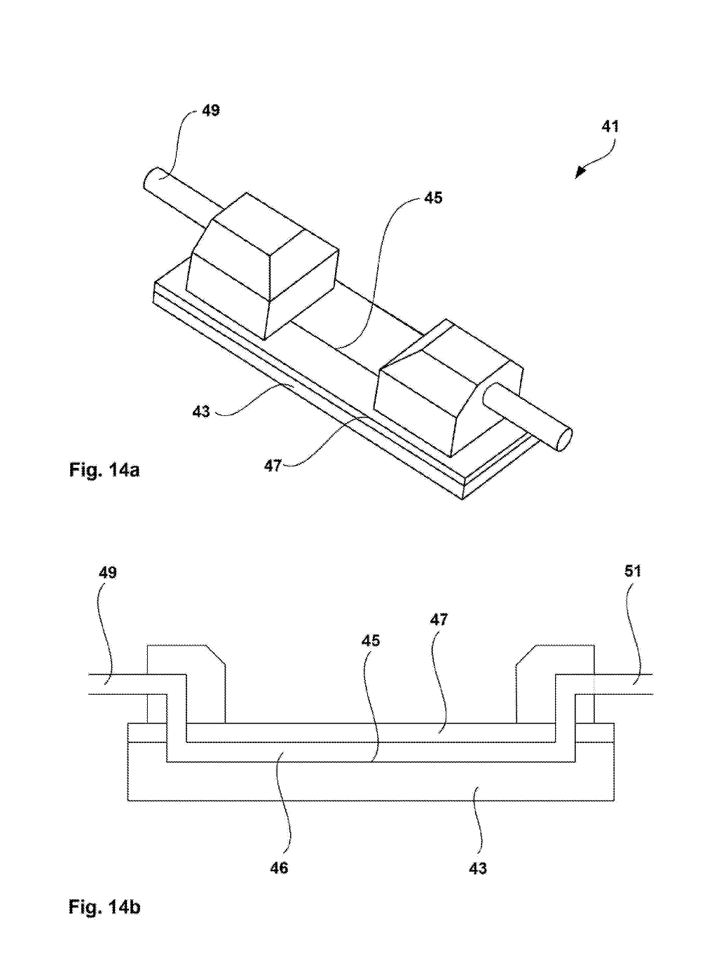

The fluid flow control means 41, that controls the fluid flow into the chamber 5 will now be described with reference to FIGS. 14a and 14b that shows a perspective view of the fluid control means 41 and a cross-sectioned view of the fluid control means 41 along the length of a groove 45. The fluid control means 41 include a first substrate 43 provided with a groove 45. A second substrate 47 is provided to cover the groove 45 so that the groove 45 defines a fluid passage 46. An inlet 49 is fluidly connected to one end of groove 45 and an outlet 51 is fluidly connected to another end of the groove 45.

The flow rate of the fluid 7 through the fluid flow control means 41 may be dependent on the pressure difference between the inlet 49 and outlet 51, the working temperature and specific properties of the fluid 7. The flow rate is also dependent on the dimensions and structural configuration of the fluid passage 46, including the cross-sectional area of the passage, the length of the fluid passage 46, the area of the passage walls and the material properties of the first and second substrate 43, 47 that define the passage wall.

In the illustrated embodiment, the first and second substrates 43, 47 are substantially planar. The first and second substrates 43, 47 may be made of one or more of silicon wafer and/or glass. In one embodiment, the first substrate 43 is made of a silicon wafer with the second substrate 47 may be made of glass plate attached thereto.

To define the fluid passage provided by groove 45 when the first and second substrates 43, 47 are connectedly engaged, the first and second substrates 43, 47 may be bonded together. Bonding may be achieved by using an adhesive. In one example a thermally conductive epoxy may be used to bond the first and second substrates 43, 47 and to seal the fluid control means 41 assembly. In another embodiment, a glass substrate may be bonded to a silicon substrate by anodic bonding.

The first substrate 43 may have a groove 45 cut with a dicing saw. In one alternative, the groove may be created with a dry etching process.

The groove 45 may have a cross-sectional dimension and length that is, in part, dictated by the required flow rate and other factors as discussed above. In one example, the groove 45 has a cross-section of about 40 micrometres wide by 20 micrometres deep. In other examples the groove 45 has a cross-sectional dimension in the range of about 3 by 3 micrometres to about 10 by 10 micrometres.

The fluid flow control means 41 may advantageously provide precise fluid flow rates to the chamber 5 of the thruster 1. In some application, such as in miniature satellites, the fluid flow rate is small, such as in the order of 1 standard cubic centimetre per minute or less. Such flow rates require precise control of fluid 7 that can be achieved by the characteristics of the fluid passage defined by groove 45.

When determining characteristics of the fluid control means 41 and the thruster 1, the mass flow, volume flow and leak rate (through the fluid control means 41) may be determined by the followings formulas:

$$\begin{matrix}Mass flow \text{:} {m}^{•} = A \cdot Ψ \cdot \sqrt{2 \cdot {p}_{i} \cdot {ρ}_{i}} & ( Equation 6 ) \\ Volume flow \text{:} {V}^{•} = \frac{{m}^{•}}{{ρ}_{a}} & ( Equation 7 ) \\ Leak rate \text{:} {ρ}_{a} \cdot {V}^{•} = \frac{{p}_{a} \cdot V}{t} = {m}^{•} \cdot R \cdot {T}_{a} \\ A \text{:} Leak area \\ Ψ \text{:} throughput function \\ {p}_{i} \text{:} pressure inside \\ {ρ}_{i} \text{:} density inside \\ {p}_{a} \text{:} pressure outside \\ {ρ}_{a} \text{:} density outside \\ R \text{:} specific gas constant \\ ( air : 287 , Helium : 2078 [ J / ( kg * K ) ] ) \\ {T}_{a} \text{:} Temperature outside & ( Equation 8 )\end{matrix}$$

### Fluid Tank 61

The fluid tank 61 includes a fluid chamber 63 to store the fluid 7. The fluid 7 in the fluid chamber 63 may be in a liquid state. Generally, fluid 7 stored in a liquid state may be advantageous as it allows the maximum storage of fluid 7 for a given volume of the fluid chamber 63. That is, it may provide the most efficient use of space which is at a premium for satellite applications.

However, when providing the fluid 7 into the chamber 5 for ionisation and acceleration, it may be desirable to have the fluid 7 in a gaseous form. The fluid 7 in the gaseous form may assist the ionisation process as it may require less energy to ionise gaseous fluid compared to liquid fluid. Furthermore, if the fluid 7 flows through the conduits 69, 71, 73 in liquid form, this may result in an undesirably large amount of fluid 7 to flow into the chamber 7 that may affect the efficient operation of the thruster 1.

To prevent or ameliorate the fluid 7 in liquid form from flowing out of the fluid tank 61, a membrane 65 is provided to form a liquid barrier. The membrane 65 may include properties, such as microscopic apertures, to allow gaseous fluid 7 to pass from the fluid chamber 63 to the conduit 69. In one example, the microscopic apertures in the membrane 65 may be in the range of 0.3 to 5 micrometres. It is to be appreciated that the membrane material and/or aperture size may be selected to suit the type of fluid 7 to achieve the above mentioned function.

### The Fluid 7

The fluid 7 is of a type that can be ionised in the thruster 1. The fluid 7 may be homogenous or alternatively a heterogeneous mixture.

One fuel may include hydrogen, where in the molecular form H₂, is supplied into the chamber 5 via the fluid inlet 23. At least some of the hydrogen is then ionised and accelerated as discussed in this description.

A gas, liquid or solid that can be atomised and strike plasma between the anode and cathode in the chamber may also be suitable for the thruster. For example, some other fluids may include water, isopropyl alcohol, methanol, ethanol, propanol (including n-propanol and isopropanol), and butanol (including n-butanol and t-butanol). It is also to be appreciated that the fluid 7 may be a mixture of fluids and, in one example, may include a mixture of isopropyl alcohol and water. In one embodiment, the alcohol is isopropyl alcohol or similar.

### Satellite 900

One application for a thruster is for manoeuvring a spacecraft. The efficiency of spacecraft propulsion may be determined by the change in momentum (impulse) per unit weight of propellant, which is known as specific impulse. Greater propulsion efficiency is achieved by increasing the specific impulse. Electric propulsion methods are desirable as they produce high specific impulse compared to other known technologies. This makes them desirable for spacecraft where mass and space considerations are important and may allow a reduced amount of propelled to be carried.

FIG. 15 illustrates a satellite 900 including a thruster 1. The thruster 1 may be used for one or more of the following, including attitude control of the satellite 900, formation flying with other satellites, orbit station keeping by applying thrust to maintain altitude and extend orbit life and deep space exploration.

In one embodiment, the satellite 900 also includes additional thrusters 901. Having two or more thrusters, in particular when directed in different directions, may be facilitate attitude control of the satellite 900.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A thruster comprising:
a chamber to contain a fluid;
a plurality of nozzles to exhaust neutral particles derived from the fluid in the chamber, wherein each nozzle has a converging section and the converging section comprises a first electrode;
a second electrode located distal to the first electrode to provide a voltage differential between the first and second electrodes sufficient to create plasma ions from the fluid and the voltage differential accelerates the plasma ions on a flow path through the converging section, and
wherein at least one or more of the accelerated plasma ions are neutralised to form the neutral particles by charge exchange with other neutral particles, or by recombination with electrons, on the flow path.

2. A thruster according to claim 1, wherein the plurality of nozzles are arranged in an array.

3. A thruster according to claim 1, wherein the array comprises a two-dimensional array with regular spacing between the plurality of nozzles.

4. A thruster according to claim 1, the thruster comprising a nozzle element having the plurality of nozzles in an array.

5. A thruster according to claim 4, wherein at least a portion of the nozzle element, having the plurality of nozzles in an array, is substantially planar.

6. A thruster according to claim 4, wherein the nozzle element is formed of an electrically conductive material and the nozzle element forms at least part of the first electrode.

7. A thruster according to claim 1, wherein the nozzle comprises an electrically conductive lining at the converging section to form at least part of the first electrode.

8. A thruster according to claim 1, wherein the converging section of each of the nozzles converges towards a respective nozzle axis, and wherein the respective nozzle axis of each of the plurality of nozzles is substantially parallel.

9. A thruster according to claim 1, wherein the converging section defines a nozzle aperture that is frustoconical.

10. A thruster according to claim 9, wherein the nozzle aperture has a generator angle of between 5 degrees and 45 degrees from a nozzle axis of the nozzle aperture.

11. A thruster according to claim 9, wherein the frustoconical nozzle aperture has a substantially circular inlet and a substantially circular outlet diameter, wherein the substantially circular inlet has an inlet diameter in the range of 1 to 20 millimetres and the substantially circular outlet has an outlet diameter in the range of 0.1 to 8 millimetres.

12. A thruster according to claim 11, wherein the distance between the inlet diameter and outlet diameter along the nozzle axis is in the range of 1 to 20 millimetres.

13. A thruster according to claim 1, wherein the plurality of nozzles are disposed at a first end of the chamber and the second electrode is disposed at a second end of the chamber and wherein at least one chamber wall formed of non-conductive material separates the first and second ends.

14. A thruster according to claim 13, further comprising at least one shield located in the chamber proximal to a chamber wall, wherein the shield is electrically isolated from the first and second electrode.

15. A thruster according to claim 1, further comprising a cover to define at least part of the chamber, and wherein the cover is formed of an electrically conductive material and is at least part of the second electrode.

16. A thruster according to claim 1, wherein the thruster is a substantially rectangular cuboid.

17. A thruster according to claim 1, further comprising a voltage source connected to the first and second electrodes so that the first electrode is a cathode and the second electrode is an anode.

18. A thruster according to claim 17, further comprising a third electrode located adjacent to a path of the exhausted particles, wherein the third electrode is a second anode.

19. A thruster according to claim 1, further comprising a fluid inlet to supply fluid to the chamber, wherein the fluid inlet is located proximal to the second electrode.

20. A thruster according to claim 19, wherein the fluid inlet further comprises a plurality of inlets to distribute fluid entering the chamber.

21. A thruster according to claim 1, further comprising a fluid flow control means to control the fluid flow into the chamber, wherein the fluid flow control means provide fluid to maintain an operating pressure inside the chamber in accordance with the formula:
P=K/D
where
P is the pressure inside the chamber in milliTorr;
D is the distance between the first and second electrodes in millimetres; and
K is a constant between 200 and 200000 milliTorr mm.

22. A thruster according to claim 1, wherein a length of the chamber between the first and second electrode is at least 20 millimetres.

23. A thruster according to claim 1, wherein a width of the chamber is in the range of 10 to 50 millimetres.

24. A thruster according to claim 1, wherein the thruster has a flow rate in the range of 0.2 to 6 standard cubic centimetres per minute.

25. A thruster according to claim 1, wherein number of nozzles in the plurality of nozzles is in a range of 3 to 1000.

26. A thruster according to claim 1, wherein the fluid is an alcohol, water, or a combination thereof.

27. A thruster according to claim 1, further comprising a permanent magnet to provide a magnetic field in the chamber.

28. A thruster according to claim 1, wherein at least one of the chamber and nozzle is constructed of one or more silicon wafers.

29. A thruster according to claim 1, wherein the second electrode is formed of an electrically conductive material

30. A satellite comprising at least one thruster according to claim 1.

31. A method of manufacturing a thruster according to claim 1, comprising the steps of:
etching a first pattern on a first substrate;
etching a second pattern on a second substrate;
bonding the first and second substrate to form at least one of the chamber, plurality of nozzles, first electrode and second electrode of the thruster.
